(19) United States
(12) Patent Application Publication
(10) Pub. No.: US 2003/0045252 A1
(43) Pub. Date: Mar. 6, 2003

(54) Power amplifier

(75) Inventor: Sueng-il Nam, New Malden (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/227,715

(22) Filed: Aug. 26, 2002

(30) Foreign Application Priority Data
Sep. 5, 2001 (GB) 0121390.0

(51) Int. Cl. H04B 1/02; H04B 1/66; H04B 1/04; H01Q 11/12

(52) U.S. Cl. 455/127; 455/102

(57) ABSTRACT

A radio frequency power amplifier (16) for use in at least 2 frequency bands, comprises a power amplifier (32) having a passive adjustable input matching network (30), a passive variable output power matching network (34, 36) and a source (48) of tuning voltages for adjusting the input and output networks so that the power amplifier functions as a narrowband amplifier in a predetermined one of the at least 2 frequency bands. The source of tuning voltages may comprise a look-up table.

### TECHNICAL FIELD

The present invention relates to a power amplifier suitable for use in transmitters having particular, but not exclusive, application in mobile communications equipment such as equipment for GSM (Global System for Mobile Communications), DCS (Digital Communications System), PCS and UMTS (Universal Mobile Telephone System).

### BACKGROUND ART

Power amplifiers are one of the most difficult parts of a transceiver to integrate because of their large voltage swing as well as high output power. This results in a significant amount of substrate noise, which can couple to other sections of an integrated circuit chip causing noise problems and instability such as pulling effects of a voltage controlled oscillator (VCO). In order to mitigate these problems power amplifiers are usually implemented in a separate RF module. In mobile communication applications, efficiencies of over 40% have been obtained using separate RF modules. Additionally the use of high resistive silicon substrate, LTCC (low temperature co-fired ceramic) and MEMS (Micro Electro Mechanical Systems) techniques offers some range of further improvements. Conventional handsets for use in such systems use one or two power amplifiers to cover wide frequency bands required in the above mentioned mobile communications systems. Nevertheless the wide band amplifier still dominates in designs for multi-band power amplifiers in the above-mentioned applications. Wide band amplifiers are a compromise between output power and power efficiency. Especially in low power multi-band handset mobile communications applications (GSM/DCS/PCS/UMTS), this wide band design cannot offer highly efficient power amplifier design for each individual frequency band. Reducing the transmitter power efficiency reduces the lifetime of the battery. For example, having three different power amplifiers (say 33 dBm, 30 dBm and 24 dBm) with 40% power efficiency (3 V supply voltage) will require a current consumption of 2.74 Amps, while a single, common, power amplifier for all 3 frequency bands consumes only 2.1 Amps (assuming 34 dBm maximum output power with consideration of switch losses).

European Patent Specification EP-A1-0 637 131 discloses a microwave amplifier having a variable impedance load impedance matching circuit for the amplifier. The variable load impedance is externally controlled to provide a decrease in the divergence in the load impedance of the amplifier thereby giving a maximum power efficiency at a transmission frequency to be used in the amplifier. A portable telephone including the microwave amplifier controls the external control voltage supplied to the impedance matching circuit such that the power efficiency of the amplifier is maximised at the transmission frequency used or allocated by a base station during operation. Data on the DC control voltages corresponding to the frequencies to be used in the system are stored in a memory prior to operation of the phone. The data may be stored for sections of 5 MHz width in the frequency band from 824 MHz to 849 MHz. The variable impedance matching circuit is on the output side of the microwave amplifier so as to counter the effects of a duplexer becoming part of the load impedance for the final stage of the amplifier.

### DISCLOSURE OF INVENTION

An object of the present invention is to provide a variable output power amplifier.

According to one aspect of the present invention there is provided a radio frequency power amplifier for use in at least 2 frequency bands, comprising a power amplifier having a passive adjustable input matching network, a passive variable output power matching network and means for adjusting the input and output networks so that the power amplifier functions as a narrowband amplifier in a predetermined one of the at least 2 frequency bands.

Adapting what would otherwise be a wideband amplifier to function as a single narrowband amplifier has been found to provide a further improvement in efficiency of upto 27%.

According to a second aspect of the present invention there is provided a transmitter including a radio frequency power amplifier for use in at least 2 frequency bands, the power amplifier having a passive adjustable input matching network, a passive variable output power matching network and means for adjusting the input and output networks so that the power amplifier functions as a narrowband amplifier in a predetermined one of the at least 2 frequency bands.

### BRIEF DESCRIPTION OF DRAWINGS

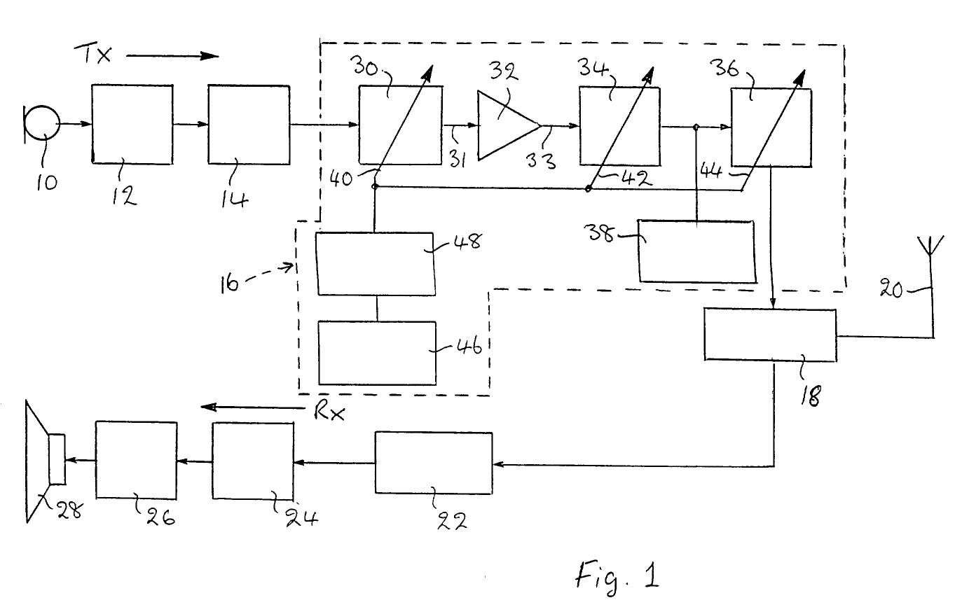

The present invention will now be described, by way of example, with reference to the single figure (labelled as FIG. 1) of the accompanying drawings, which Figure is a block schematic diagram of a transceiver including a radio frequency power amplifier made in accordance with the present invention.

### MODES FOR CARRYING OUT THE INVENTION

Referring to the drawing, the illustrated transceiver comprises a transmitter branch Tx and a receiver branch Rx. The transmitter branch Tx includes a microphone 10 which is coupled to a speech encoder 12. The output from the speech encoder 12 is applied to a modulator 14 to which is coupled a radio frequency (RF) power amplifier 16. An output of the RF power amplifier 16 is coupled to a duplexer 18 to an output of which is coupled a signal propagator, for example an antenna 20.

The receiver branch Rx includes a radio frequency front end stage 22 having an input coupled to an output of the duplexer 18. An output of the stage 22 is coupled to a demodulator 24, an output of which is coupled to a speech decoder 26. A loudspeaker 28 is coupled to an output of the decoder 26.

The RF power amplifier 16 comprises a power amplifier (PA) stage 32 which may comprise a single power amplifying transistor. A passive variable resonator matching stage 30 is coupled to an input 31 of the PA stage 32. Two passive variable matching networks 34, 36 are connected to an output 33 of the PA stage 32. The network 34 operates on the imaginary component of the amplified signal and the network 36 operates on the real component of the amplified signal. Each of the matching networks 34, 36 includes a variable capacitor, for example, a tunable high-Q passive component implemented using MEMS techniques. A source of bias voltage 38 is coupled to a conductive path between the output of the network 34 and the input to the network 36. A tuning voltage is supplied to a control input 40, 42 and 44, respectively, of the matching stage 30 and the networks 34 and 36. The tuning voltages adapt the RF power amplifier 16 so that it functions as a narrowband amplifier over the frequency band of interest. Additionally the filtering requirements of the individual system are eased.

A processor 46 controls the tuning voltage and the bias voltage source 38. A look-up table 48 stores the tuning voltages for use in adapting the passive networks, for each application, to give maximum output power with maximum efficiency. Thus a user selects the mobile communications system and/or the processor 46 recognises the system in accordance with which the transceiver is operating and the processor 46 causes the look-up table 48 to read-out the respective pre-stored tuning voltages to enable the RF power amplifier to function as a narrowband amplifier. By using tunable passive matching networks transmitter efficiencies can be increased upto a minimum of 23%, resulting in high linearity, low power dissipation and long battery life.

More particularly the output matching networks 34, 36 collectively function as a narrowband matching network for each individual operating mode. These variable matching networks are implemented using variable capacitors. The input variable resonator type matching network 30 provides some degree of frequency filtering. Once the input matching network has been determined, the output impedance is optimised to get maximum output power, minimum IMP₃ (third order intermodulation product), minimum phase shift and maximum power added efficiency. The input matching network 30 affects the output power of the amplifier 32, especially its linearity and output stability and is designed under stable and high gain conditions. In order to optimise the performance, the output impedance must trace all round a Smith chart to find the optimum load impedance.

The input matching network is designed for conjugate matching (Γ_{S}=Γᵢₙ*), leading to 50 Ω matching. The real part matching network 36 from the output port generates the real part of the load impedance, i.e. the resistance. This block transforms the resistance from 50 to the required resistance, and the required resistance will be different according to the frequency band. The imaginary part matching network 34 will control the imaginary party of the load impedance by varying reactance. The imaginary part using shunt capacitance will move in an anti-clockwise direction on the Smith chart. By selecting a series capacitance, a clockwise operation may be obtained. In this way it is possible to move power matching to a maximum power and efficiency point over a narrow frequency band. For implementing an accurate passive matching network, it is necessary to have a low loss passive element (low parasitic or high-Q component). This high-Q variable element is feasible with MEMS techniques.

The power amplifier may be implemented as part of an RF module.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of RF power amplifiers and component parts therefor and which may be used instead of or in addition to features already described herein.

1. A radio frequency power amplifier for use in at least 2 frequency bands, comprising a power amplifier having a passive adjustable input matching network, a passive variable output power matching network and means for adjusting the input and output networks so that the power amplifier functions as a narrowband amplifier in a predetermined one of the at least 2 frequency bands.

2. A power amplifier as claimed in claim 1, characterised in that the output power matching network comprises a variable real part matching network and a variable imaginary part matching network.

3. A power amplifier as claimed in claim 2, characterised in that the imaginary part matching network comprises a variable shunt capacitance.

4. A power amplifier as claimed in claim 3, characterised in that the variable shunt capacitance comprises a high-Q capacitance.

5. A power amplifier as claimed in claim 2, characterised in that the real part matching network comprises a variable resistance.

6. A power amplifier as claimed in claim 2, characterised in that the adjustable input matching network comprises a variable resonator type matching network.

7. A power amplifier as claimed in claim 6, characterised by means for supplying tuning voltages for varying at least one characteristic of the variable real part matching network, of the variable imaginary part matching network and of the variable resonator type matching network.

8. A power amplifier as claimed in claim 7, characterised in that the means for supplying tuning voltages comprises a look-up table storing tuning voltages applicable to each of the at least 2 frequency bands.

9. A module comprising a power amplifier as claimed in anyone of claims 1 to 8.

10. A transmitter including a radio frequency power amplifier for use in at least 2 frequency bands, the power amplifier having a passive adjustable input matching network, a passive variable output power matching network and means for adjusting the input and output networks so that the power amplifier functions as a narrowband amplifier in a predetermined one of the at least 2 frequency bands.
